(19) United States
(12) Patent Application Publication
(10) Pub. No.: US 2024/0337866 A1
(43) Pub. Date: Oct. 10, 2024

(54) ADJUSTING ADAPTIVE OPTICAL LENS FROM SENSED DISTANCE

(71) Applicant: Meta Platforms Technologies, LLC, Menlo Park, CA (US)

(72) Inventor: Mantas Zurauskas, Redmond, WA (US)

(21) Appl. No.: 18/419,401

(22) Filed: Jan. 22, 2024

Related U.S. Application Data
(60) Provisional application No. 63/457,587, filed on Apr. 6, 2023.

(51) Int. Cl. G02C 7/08; G02B 27/00; G02B 27/01

(52) U.S. Cl. CPC G02C 7/085; G02B 27/0093; G02B 27/0172; G02C 7/083

(57) ABSTRACT

A gaze direction of a user is determined. An object in the environment associated with the gaze direction is identified. A distance between a device and the object associated with the gaze direction is measured. The device may be a head-mounted device or a contact lens. An optical power of an adaptive optical lens of the device is adjusted in response to the distance between the device and the object in the environment.

### CROSS-REFERENCE TO RELATED APPLICATIONS

This application claims priority to U.S. provisional Application No. 63/457,587 filed Apr. 6, 2023, which is hereby incorporated by reference.

### TECHNICAL FIELD

This disclosure relates generally to optics, and in particular to adjusting optical lenses.

### BACKGROUND INFORMATION

Presbyopia is an age-related loss of lens accommodation that results in an inability to focus the eye at near-distances. It is the most common physiological change occurring in the adult eye. Currently, presbyopia is corrected by reading glasses or by glasses having different optical power in different locations in the lenses (e.g. bifocal, trifocal, or varifocal lenses).

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head-mounted device that includes an adaptive optical lens, in accordance with aspects of the disclosure.

FIG. 2 illustrates a system that includes an adaptive optical lens, an eye-tracking system, a scene-facing distance sensor, a memory, and processing logic, in accordance with aspects of the disclosure.

FIGS. 3A-3B illustrate an example liquid crystal implementation of an adaptive optical lens, in accordance with aspects of the disclosure.

FIG. 4 illustrates an example flow chart of a process of adjusting the optical power of an adaptive optical lens, in accordance with aspects of the disclosure.

FIG. 5 illustrates a system that includes a variable-focus contact lens worn on an eye of a user, in accordance with aspects of the disclosure.

FIGS. 6A-6C illustrate an example variable-focus contact lens including processing logic and a scene-facing distance sensor, in accordance with aspects of the disclosure.

### DETAILED DESCRIPTION

Embodiments of adjusting an adaptive optical lens from a sensed distance is described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

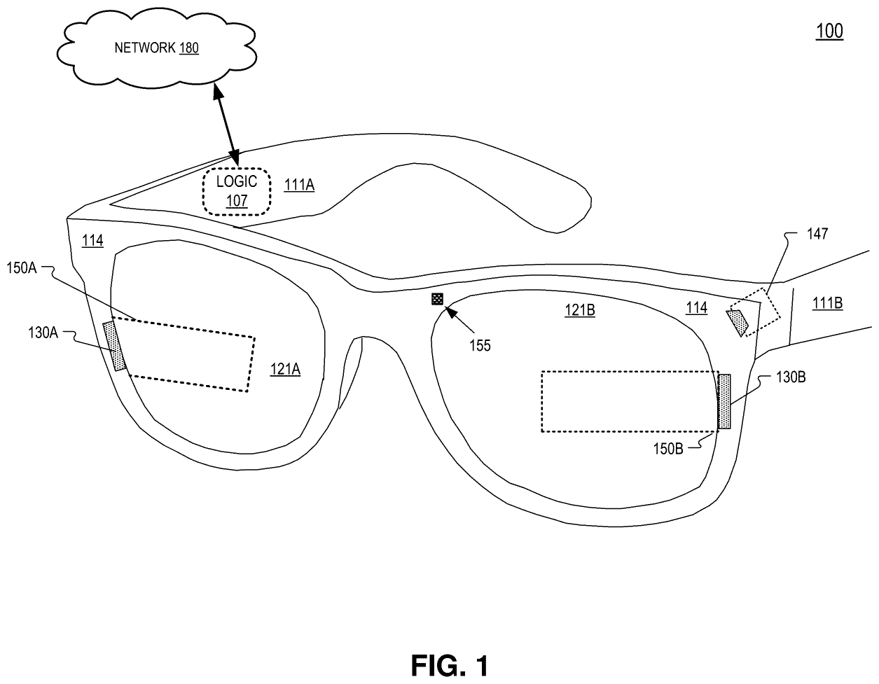

Implementations of the disclosure include adaptive vision correction for a head-mounted devices and adaptive vision correction for contact lenses. Head-mounted devices may include Virtual Reality (VR), Augmented Reality (AR), Mixed Reality (MR), or smartglasses, for example. The head-mounted devices of the disclosure may include an eye-tracking system, a scene-facing distance sensor configured to sense an environment, an adaptive optical lens, and processing logic. The adaptive optical lens can be driven to change the optical power of the head-mounted device based on the gaze direction of the user. Contact lens implementations may include a scene-facing distance sensor and an adaptive optical lens. The scene-facing distance sensor may measure a distance between the contact lens and an object (in the environment) that the scene-facing distance sensor is directed to. The scene-facing distance sensor may be directed to the object via the eye-movement since the contact lens will follow the movement of the eye. An optical power of the adaptive optical lens of the contact lens may then be adjusted in response to the measured distance between the contact lens and the object. These and other implementations are described in more detail in connection with FIGS. 1-6C.

FIG. 1 illustrates a head-mounted device 100 that includes an adaptive optical lens, in accordance with aspects of the present disclosure. Head-mounted device 100 may be electronic glasses, smartglasses, or a head-mounted display (HMD). Head-mounted device 100 includes frame 114 coupled to arms 111A and 111B. Lens assemblies 121A and 121B are mounted to frame 114. Frame 114 is configured to secure the lens assemblies 121A/121B. Lens assemblies 121A and 121B may include an adaptive optical lens that can have its optical power adjusted in response to a distance of an object associated with a gaze direction of a user of head-mounted device 100. The illustrated head-mounted device 100 is configured to be worn on or about a head of a wearer of head-mounted device 100.

In the head-mounted device 100 illustrated in FIG. 1, each lens assembly 121A/121B includes a display waveguide 150A/150B to direct image light generated by displays 130A/130B to an eyebox region for viewing by a user of head-mounted device 100. Displays 130A/130B may include a beam-scanning display that includes a scanning mirror, for example. Displays 130A/130B may include a liquid crystal on silicon (LCOS) display for directing image light to a wearer of head-mounted device 100 to present virtual images. While head-mounted device 100 is illustrated as a head-mounted display, implementations of the disclosure may also be utilized on head-mounted devices (e.g. smartglasses) that don't necessarily include a display.

Lens assemblies 121A and 121B may appear transparent to a user to facilitate augmented reality (AR) or mixed reality (MR) to enable a user to view scene light from the external environment around them while also viewing display light that includes a virtual image generated by a display of the head-mounted device 100. Lens assemblies 121A and 121B may include two or more optical layers for different functionalities such as display, eye-tracking, and/or optical power. An adaptive optical lens may be included in lens assemblies 121A and 121B to adjust the optical power of the lens assembly.

Frame 114 and arms 111 may include supporting hardware of head-mounted device 100 such as processing logic 107, wired and/or wireless data interface for sending and receiving data, graphic processors, and one or more memories for storing data and computer-executable instructions. Processing logic 107 may include circuitry, logic, instructions stored in a machine-readable storage medium, ASIC circuitry, FPGA circuitry, and/or one or more processors. In one embodiment, head-mounted device 100 may be configured to receive wired power. In one embodiment, head-mounted device 100 is configured to be powered by one or more batteries. In one embodiment, head-mounted device 100 may be configured to receive wired data including video data via a wired communication channel. In one embodiment, head-mounted device 100 is configured to receive wireless data including video data via a wireless communication channel. Processing logic 107 is illustrated as included in arm 111A of head-mounted device 100, although processing logic 107 may be disposed anywhere in the frame 114 or arms 111 of head-mounted device 100. Processing logic 107 may be communicatively coupled to a network 180 to provide data to network 180 and/or access data within network 180. The communication channel between processing logic 107 and network 180 may be wired or wireless.

Head-mounted device 100 also includes one or more eye-tracking systems 147. Eye-tracking system 147 may include a complementary metal-oxide semiconductor (CMOS) image sensor. While not specifically illustrated, the eye-tracking system 147 may include light sources that illuminate an eyebox region with illumination light. The illumination light may be infrared or near-infrared illumination light. Some implementations may include around-the-lens (ATL) light sources that are configured to illuminate an eyebox region with illumination light. In other implementations, the light sources may be “in-field” and disposed with lens assembly 121B in order to illuminate the eyebox region more directly. The light sources may include LEDs or lasers. In an implementation, the light sources include vertical-cavity surface emitting lasers (VCSELs).

An image sensor of eye-tracking system 147 may include an infrared filter that receives a narrow-band infrared wavelength and is placed over the image sensor so it is sensitive to the narrow-band infrared wavelength emitted by the light sources while rejecting visible light and wavelengths outside the narrow-band. Eye-tracking system 147 may be other than a light-based system, in some implementations.

Head-mounted device 100 also includes a scene-facing distance sensor 155 configured to sense an environment around the head-mounted device 100. Scene-facing distance sensor 155 may include an image sensor, a time-of-flight (ToF) sensor, or any other suitable distance sensor. Scene-facing distance sensor 155 includes an infrared distance sensor, in some implementations. Head-mounted device 100 may include a plurality of scene-facing distance sensors, in some implementations.

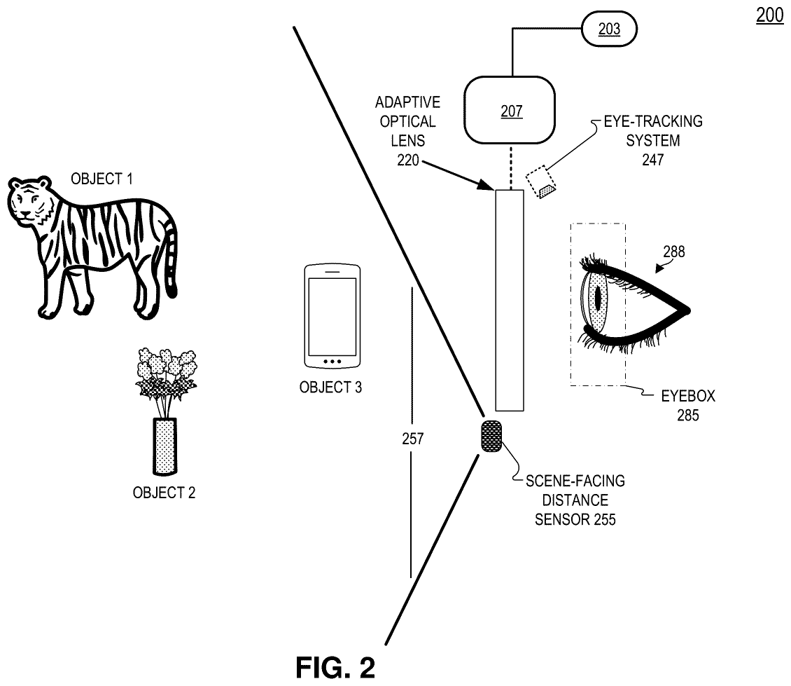

FIG. 2 illustrates a system 200 that includes an adaptive optical lens 220, an eye-tracking system 247, a scene-facing distance sensor 255, memory 203, and processing logic 207, in accordance with aspects of the disclosure. System 200 may be included in various devices described in the disclosure. Adaptive optical lens 220 may be included in a lens assembly 121A/B in the FOV of a user of a head-mounted device 100. Eye-tracking system 247 may determine a gaze direction of the eye 288 residing in an eyebox 285 of a user of a head-mounted device.

An object in the environment may be identified by processing logic 207 that is associated with the gaze direction determined by eye-tracking system 247. By way of example, eye 288 may be looking at object 1, object 2, or object 3. Object 1 (the tiger in FIG. 2) may be located in the far-field and object 3 (smartphone in FIG. 2) may be in the near-field with object 2 (flowers in the vase in FIG. 2) located between object 1 and object 3. Objects 1, 2, and 3 are positioned within a field of view (FOV) 257 of scene-facing distance sensor 255. Processing logic 207 may drive scene-facing distance sensor 255 to measure a distance between the head-mounted device and the object associated with the gaze direction. Consequently, if the gaze direction of eye 288 is associated with object 2, scene-facing distance sensor 255 will measure the distance between the head-mounted device (or scene-facing distance sensor 255 mounted to head-mounted device 100) and object 2. Processing logic 207 may then adjust an optical power of the adaptive optical lens 220 in response to the distance between the head-mounted device and object 2 in order to bring the object into focus for the user. This may allow the user to focus on the object that they are actually viewing since the objects may have varying distances (e.g. near-field, mid-field, or far-field) from the user wearing the head-mounted device.

In some implementations, identifying the object in the environment associated with the gaze direction includes selecting the object from a plurality of objects included in an environmental map of the environment of system 200. Each object in the environmental map may have a distance associated with the object, where the distance is a measurement between the object and the scene-facing distance sensor 255. Scene-facing distance sensor 255 may be continually mapping the entire environment by imaging the environment. Imaging the environment with scene-facing distance sensor 255 may include capturing images with one or more image sensors. Scene-facing distance sensor 255 may include Simultaneous Localization and Mapping (SLAM) cameras. Imaging the environment with scene-facing distance sensor 255 may include non-light based sensing systems (e.g. ultrasonic or radio frequency systems).

The adaptive optical lens 220 may include a liquid lens to vary the optical power. Adaptive optical lens 220 may be driven to a particular optical power associated with the distance of an object that eye 288 is gazing at. In an implementation, processing logic 207 drives an optical power on to adaptive optical lens 220 based on a prescription correction that is specific to a particular user of a head-mounted device or contact lens. The prescription correction for the user may be stored in a user profile written to memory 203 that is accessible to processing logic 207. In an implementation, processing logic 207 drives an optical power on to adaptive optical lens 220 based on a pre-recorded calibration data stored in memory 203 that is accessible to processing logic 207. The pre-recorded calibration data may be included in a look-up-table having distance-optical power pairs so that a given distance in the loop-up-table has a corresponding optical power that is driven onto adaptive optical lens 220.

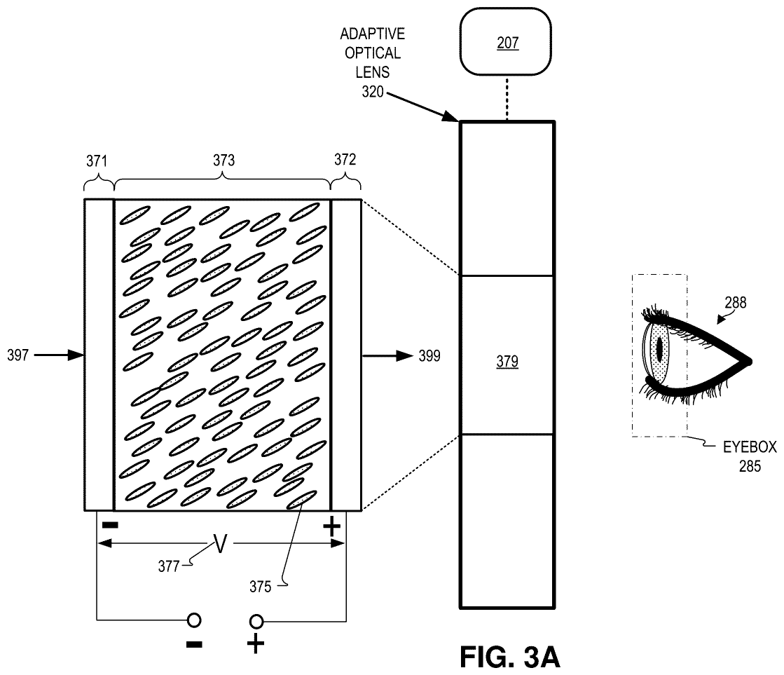

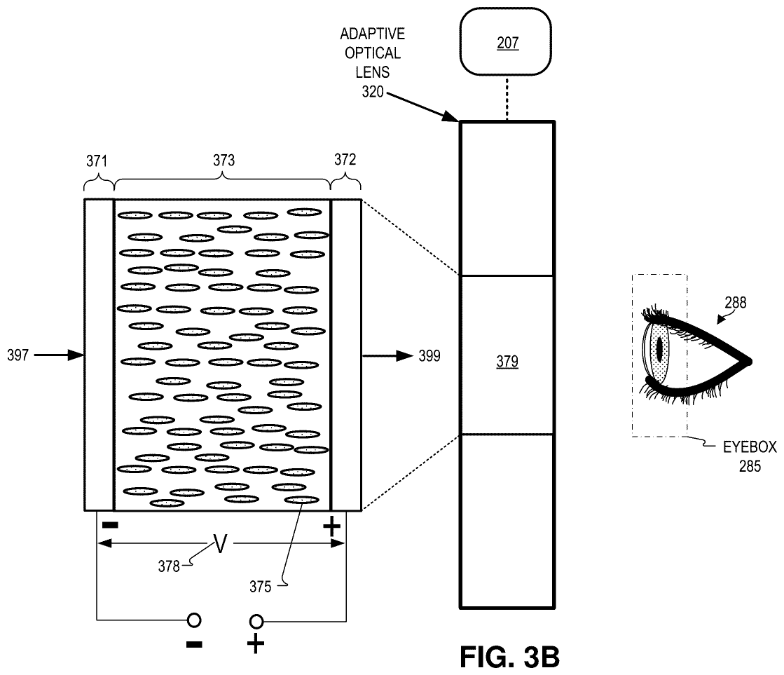

FIGS. 3A-3B illustrate an example liquid crystal implementation of adaptive optical lens 220, in accordance with aspects of the disclosure. Adaptive optical lens 320 includes liquid crystals configured to change orientations in response to a voltage applied across the liquid crystals and the optical power of the adaptive optical lens 320 changes when the orientation of the liquid crystal changes. FIG. 3A illustrates an example adaptive optical lens 320 providing a first optical power and FIG. 3B illustrates adaptive optical lens 320 providing a second optical power.

FIG. 3A illustrates an exploded view of section 379 of adaptive optical lens 320 where section 379 includes a liquid crystal layer 373 disposed between first layer 371 and second layer 372. Liquid crystals 375 are confined to liquid crystal layer 373. A voltage (V) may be applied across layers 371 and 372 to adjust the orientation of liquid crystals 375. Since liquid crystals 375 are anisotropic, the refractive index of the liquid crystals 375 with respect to incoming light 397 varies based on the orientation of liquid crystals 375. In FIG. 3A, a first voltage 377 is applied across layers 371 and 372 to drive liquid crystals 375 to a first orientation corresponding with a first refractive index that imparts a first optical power to incoming light 397 in order to focus exit light 399 to eye 288.

In FIG. 3B, a second voltage 378 (different from the first voltage of FIG. 3A) is applied across layers 371 and 372 to drive liquid crystals 375 to a second orientation corresponding with a second refractive index that provides a second optical power to incoming light 397 in order to focus exit light 399 to eye 288. Processing logic 207 may drive the different voltages (V) onto layers 371 and 372 in order change the orientation/alignment of liquid crystals 375 and vary the optical power of adaptive optical lens 320.

The optical power that the adaptive optical lens 320 is adjusted to may be specific to the user. The optical power that the adaptive optical lens 320 is adjusted to may be pre-recorded calibration data.

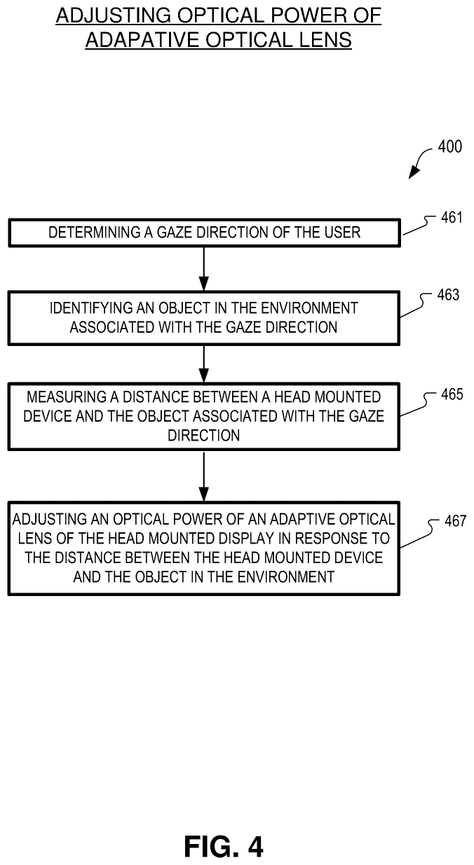

FIG. 4 illustrates an example flow chart of a process 400 of adjusting the optical power of an adaptive optical lens, in accordance with aspects of the disclosure. The order in which some or all of the process blocks appear in process 400 should not be deemed limiting. Rather, one of ordinary skill in the art having the benefit of the present disclosure will understand that some of the process blocks may be executed in a variety of orders not illustrated, or even in parallel. All or a portion of the process blocks of process 400 may be executed by processing logic 107 or 207, for example.

In process block 461, a gaze direction of the user is determined. The gaze direction may be determined by an eye-tracking system.

In process block 463, an object in the environment associated with the gaze direction is identified. In an implementation, identifying the object in the environment associated with the gaze direction includes selecting the object from a plurality of objects included in an environmental map of the environment.

In process block 465, a distance is measured between the head-mounted device and the object associated with the gaze direction. When an environmental map is used to associate the object with gaze direction, the distance may be obtained from the environmental map.

In process block 467, an optical power of an adaptive optical lens is adjusted in response to the distance between the head-mounted device and the object in the environment.

In an implementation, adjusting the optical power of the adaptive optical lens includes matching the distance to a corresponding optical power and driving the corresponding optical power as the optical power on to the adaptive optical lens to focus the object for viewing by an eye of a user of the head-mounted device. In an implementation, the corresponding optical power is a prescription correction specific to the user of the head-mounted device. In an implementation, the corresponding optical power is pre-recorded calibration data.

After executing process block 467, process 400 may return to process block 461.

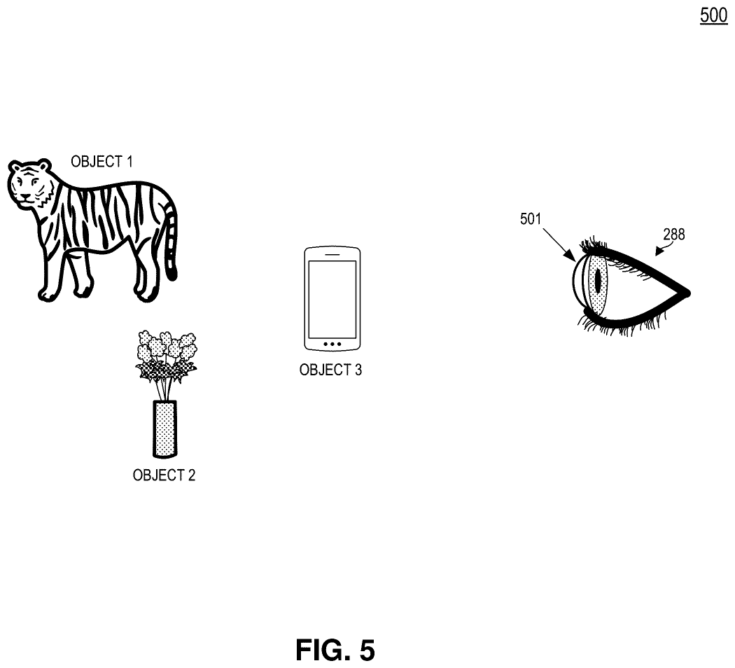

FIG. 5 illustrates a system 500 that includes a variable-focus contact lens 501 worn on an eye 288 of a user, in accordance with aspects of the disclosure. Object 1, object 2, and object 3 are in the field of view of eye 288. Object 1 (the tiger) may be located in the far-field and object 3 (smartphone) may be in the near-field with object 2 (flowers in the vase) located between object 1 and object 3.

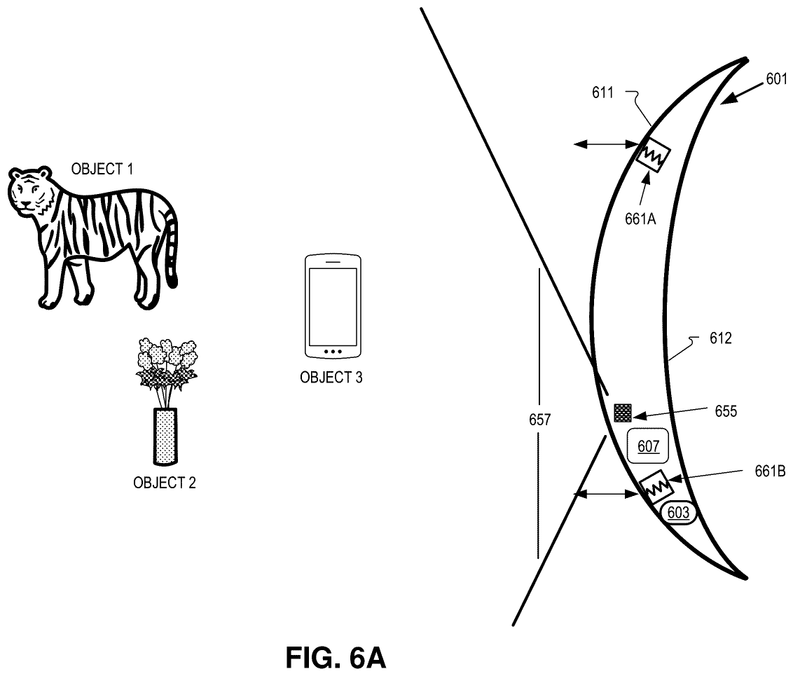

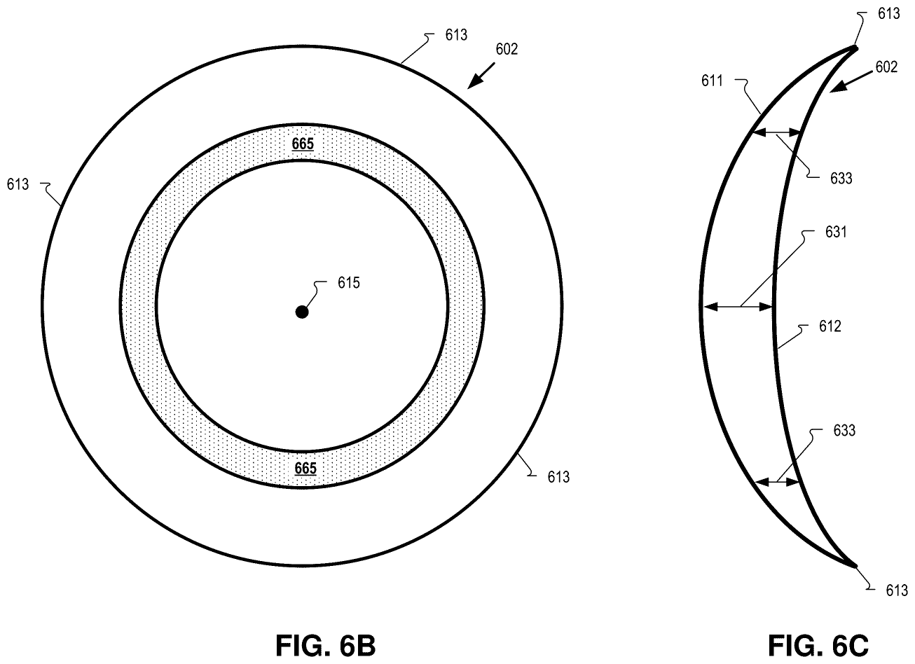

FIG. 6A illustrates an example variable-focus contact lens 601 including processing logic 607 and scene-facing distance sensor 655, in accordance with aspects of the disclosure. In some implementations, a memory 603 may be communicatively coupled to processing logic 607. In other implementations, a memory may be internal to (within the same package as) processing logic 607. Objects 1, 2, and 3 are positioned within a field of view (FOV) 657 of scene-facing distance sensor 655. Scene-facing distance sensor 655 make include features described with respect to scene-facing distance sensor 155 and/or 255.

Variable-focus contact lens 601 also includes an adaptive optical lens configured to adjust at least one surface of the variable-focus contact lens 601. Variable-focus contact lens 601 includes a first surface 611 disposed opposite a second eye-side surface 612. In the illustration of FIG. 6A, actuators 661A and 661B vary the distance of first surface 611 from second eye-side surface 612 in order to adjust the optical power of the adaptive optical lens of variable-focus contact lens 601. Actuators 661A and 661B may be microfluidic actuators, in some implementations. The microfluidic actuators may operate a network of microchannels filled with fluid. When a pressure difference is applied across these microchannels by the microfluidic actuators, the fluid moves, causing expansion and contraction. This expansion and contraction may adjust the shape of the adaptive optical lens.

Variable-focus contact lens 601 may operate similarly to system 200 of FIG. 2 except that variable-focus contact lens 601 does not necessarily require an eye-tracking system to determine gaze direction. Rather, the variable-focus contact lens 601 will generally move with the eye and therefore scene-facing distance sensor 655 will generally be pointed in the same direction as the eye 288 is gazing. This is advantageous for the potential elimination of processing steps of determining the gaze direction of the user to identify an object that the user is gazing at. This elimination of processing steps for processing logic 607 may be particularly important in the power-sensitive context of a variable-focus contact lens.

FIG. 6B illustrates a plan view of an example adaptive optical lens 602 that may be included in variable-focus contact lens 601. Adaptive optical lens 602 includes edges 613 and center 615. FIG. 6C shows that one or more actuators may vary an outer-ring dimension 633 along an outer ring of the adaptive optical lens 602 in order to change the outer-ring dimension 633 with respect to a fixed center-thickness dimension 631 in a center 615 of the adaptive optical lens 602 shown in FIG. 6B. An anchor structure may be disposed between the surfaces 611 and 612 at center 615 to maintain the fixed distance at the center of adaptive optical lens 602. Changing the outer-ring dimension 633 of the outer ring while center-thickness dimension 631 at the center 615 remains fixed changes the curvature of the first surface 611 and/or eye-side surface 612, and in turn, the optical power of adaptive optical lens 602. The one or more actuators may be disposed in an actuator zone 665 in the outer ring of the adaptive optical lens 602. The actuators and the actuator zone 665 may be located closer to edge 613 of adaptive optical lens 602 than is illustrated in FIG. 6B, in some implementations. In some implementations, the microchannels that are controlled by the microfluid actuators are disposed in actuator zone 665.

In some implementations, the curvature of adaptive optical lens 602 may be varied by pushing/pulling fluid from optically inactive regions of the lens to/from optically active regions of the lens. The optically active region of the lens is the portion of adaptive optical lens 602 that is positioned over the pupil while the optically inactive region of the lens may be the portion of adaptive optical lens 602 that would be positioned over the iris and sclera. The optically active regions of the adaptive optical lens may be surrounded by the optically inactive regions of the adaptive optical lens just as the iris surrounds the pupil. Of course, the change in the curvature of adaptive optical lens 602 in optically active parts of adaptive optical lens 602 also translates to optical power adjustments.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. logic 107/207/607) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I2C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A head-mounted device comprising:
an eye-tracking system;
a scene-facing distance sensor configured to sense an environment;
an adaptive optical lens; and
processing logic configured to:
determine a gaze direction of a user;
identify an object in the environment associated with the gaze direction;
drive the scene-facing distance sensor to measure a distance between the head-mounted device and the object associated with the gaze direction; and
adjust an optical power of the adaptive optical lens in response to the distance between the head-mounted device and the object in the environment.

2. The head-mounted device of claim 1, wherein the adaptive optical lens includes a liquid lens.

3. The head-mounted device of claim 1, wherein the adaptive optical lens includes liquid crystals configured to change orientations in response to a voltage applied across the liquid crystals, and wherein the optical power of the adaptive optical lens changes when the orientation of the liquid crystal changes.

4. The head-mounted device of claim 1, wherein the scene-facing distance sensor includes an image sensor.

5. The head-mounted device of claim 1, wherein the scene-facing distance sensor includes an infrared distance sensor.

6. The head-mounted device of claim 1, wherein adjusting the optical power of the adaptive optical lens includes:
matching the distance to a corresponding optical power; and
driving the corresponding optical power as the optical power on to the adaptive optical lens to focus the object for viewing by an eye of a user of the head-mounted device.

7. The head-mounted device of claim 6, wherein the corresponding optical power is a prescription correction specific to the user of the head-mounted device.

8. The head-mounted device of claim 6, wherein the corresponding optical power is pre-recorded calibration data.

9. The head-mounted device of claim 1, wherein identifying the object in the environment associated with the gaze direction includes selecting the object from a plurality of objects included in an environmental map of the environment.

10. A variable-focus contact lens comprising:
a scene-facing distance sensor configured to sense an environment;
an adaptive optical lens configured to adjust a first surface of the variable-focus contact lens; and
processing logic configured to:
drive the scene-facing distance sensor to measure a distance between scene-facing distance sensor and an object that the scene-facing distance sensor is directed to, wherein the scene-facing distance sensor is directed to align with a gaze of a wearer of the variable-focus contact lens; and
adjust an optical power of the adaptive optical lens in response to the distance between the scene-facing distance sensor and the object in the environment.

11. The variable-focus contact lens of claim 10, wherein adjusting the optical power of the adaptive optical lens includes:
matching the distance to a corresponding optical power; and
driving the corresponding optical power as the optical power on to the adaptive optical lens to focus the object for viewing by an eye of a user of the variable-focus contact lens.

12. The variable-focus contact lens of claim 11, wherein adjusting the optical power of the adaptive optical lens includes pushing or pulling fluid between optically inactive regions of the adaptive optical lens and optically active regions of the adaptive optical lens, the optically active regions of the adaptive optical lens being surrounded by the optically inactive regions.

13. The variable-focus contact lens of claim 10, wherein adjusting the optical power of the adaptive optical lens includes activating one or more microfluidic actuators to adjust a pressure of fluid in one or more microchannels of the adaptive optical lens, wherein a center-thickness dimension of the adaptive optical lens remains fixed and an outer-ring dimension of the adaptive optical lens is adjusted in response to the pressure modulated by the one or more microfluidic actuators.

14. The variable-focus contact lens of claim 10, wherein the scene-facing distance sensor includes an infrared distance sensor.

15. The variable-focus contact lens of claim 10, wherein the scene-facing distance sensor includes a Time-of-Flight (ToF) sensor.

16. A computer-implemented method comprising:
determining a gaze direction of a user;
identifying an object in an environment associated with the gaze direction;
measuring a distance between a head-mounted device and the object associated with the gaze direction; and
adjusting an optical power of an adaptive optical lens of the head-mounted device in response to the distance between the head-mounted device and the object in the environment.

17. The computer-implemented method of claim 16, wherein adjusting the optical power of the adaptive optical lens includes:
matching the distance to a corresponding optical power; and
driving the corresponding optical power as the optical power on to the adaptive optical lens to focus the object for viewing by an eye of a user of the head-mounted device.

18. The computer-implemented method of claim 17, wherein the corresponding optical power is a prescription correction specific to the user of the head-mounted device.

19. The computer-implemented method of claim 17, wherein the corresponding optical power is pre-recorded calibration data.

20. The computer-implemented method of claim 16, wherein identifying the object in the environment associated with the gaze direction includes selecting the object from a plurality of objects included in an environmental map of the environment.
